(19) United States
(12) Patent Application Publication
(10) Pub. No.: US 2004/0133782 A1
(43) Pub. Date: Jul. 8, 2004

(54) Anonymous electronic transactions using auditable membership proofs

(75) Inventors: Tomas Sander, San Francisco, CA (US); Amon Ta-Shma, Tel-Aviv (IL)

Correspondence Address: FISH & RICHARDSON P.C., 3300 DAIN RAUSCHER PLAZA, 60 SOUTH SIXTH STREET, MINNEAPOLIS, MN, 55402, US

(73) Assignee: International Computer Science Institute, a California corporation

(21) Appl. No.: 10/642,390

(22) Filed: Aug. 15, 2003

Related U.S. Application Data
(63) Continuation of application No. 09/637,475, filed on Aug. 11, 2000, now abandoned.
(60) Provisional application No. 60/148,467, filed on Aug. 11, 1999.

(51) Int. Cl. H04L 9/00

(52) U.S. Cl. 713/170

(57) ABSTRACT

Systems and methods for executing electronic transactions on an anonymous basis using blind auditable membership proofs. By making use of a new cryptographic primitive, electronic transactions such as payment, voting, investment, redemption of tax coupon, and international currency transfer may be made both anonymous and auditable. In an electronic payment system according to the present invention, a user submits information identifying a coin to a bank which in turn validates the coin and adds it to a public list of valid coins. To make a payment using the coin, the user presents an efficient auditable membership proof to a merchant in the form of a zero knowledge argument which proves that the user knows the authenticating information for an unspecified coin in the public list of valid coins. The merchant verifies the zero knowledge argument, accepts the coin as payment, and presents certain authenticating information to the bank. After verifying the merchant's identity and the validity of the coin referenced in the authenticating information, the bank credits the merchant's account and removes the coin from the public list of valid coins. Thereby the user makes payment with complete anonymity while authorities are given the necessary opportunity to monitor and audit the transactions to help deter and prevent bank robbery, blackmail, money laundering and other illegality.

This application claims priority from U.S. Provisional Application Serial No. 60/148,467 filed Aug. 11, 1999, the entire content of which is incorporated herein by reference.

### BACKGROUND

The invention relates to electronic systems and methods for executing electronic transactions on an anonymous basis using auditable membership proofs.

Techniques for executing electronic transactions on an anonymous basis are important for protection of privacy in an electronic world. Payment, voting, and investment transactions are examples of electronic transactions in which anonymity may be desirable. Unfortunately, anonymity for electronic transactions permits potential abuses and illegal activity.

One notable example of illegal activity involving anonymous transactions is bank robbery. In the bank robbery attack, the secret key the bank uses for signing coins is stolen, and the attacker issues valid unreported money. Such an attack can be devastating as in many prior art systems no one is able to detect that there is false money in the system until the amount of deposited money surpasses the amount of withdrawn money. By that time, the whole market is flooded with counterfeited money, and the system may collapse.

Other potential abuses of anonymous systems include blackmail. Blackmailers could commit a “perfect” blackmailing crime by using anonymous communication channels and anonymous electronic cash.

Money laundering and tax evasion are also problems with prior art anonymous transaction systems. The ability to move money around anonymously at the speed of light greatly facilitates tax evasion. Fighting money laundering is extremely difficult in an entirely anonymous electronic payment system because large amounts of money can be almost instantaneously transferred internationally.

Many of these disadvantages inhere from the use of blind signatures. If the secret key of a bank using such a system is compromised, as by an insider, the bank can be forced to issue unreported, valid money. Furthermore, the fact that prior art systems are signature-based prevents any effective monitoring of the system. By the time a security breach is detected, large sums of anonymous money may already have been issued.

Concerns about anonymous electronic cash systems have been addressed in part by “escrowed cash” systems. In escrowed cash systems, payments are anonymous from the perspective of users, merchants, and banks, but trustees are able to revoke the anonymity of each individual payment transaction. Escrowed cash systems thus strike a compromise between anonymity, on the one hand, and the authorities' need to investigate transactions in connection with crime-fighting efforts, on the other.

Escrowed cash systems have several shortcomings. First, absolute privacy is not assured. Anonymity can be revoked by the trustees at any time. This has triggered strong opposition from civil rights groups and corporations having a significant presence in the computer industry.

Second, escrowed cash does not enable authorities to fight crime effectively. Escrowed cash systems permit anonymity to be revoked upon suspicion, but that merely reveals the money trail involving transactions executed by those to whom other evidence already points. All remaining transactions, many of which may have a connection to the crime at issue, remain anonymous. That enables criminals to effectively conceal illegal transactions in an escrowed system by implementing simple, widely known techniques. Escrowed cash systems provide no tool that helps authorities locate suspicious activities.

Third, most escrowed cash systems are signature-based and thus suffer from the disadvantages discussed above.

Fourth, escrowed cash systems are very hard to secure against blackmailing attacks. In a blackmailing attack, the blackmailer forces the bank to issue valid coins via anonymous communication channels that are indistinguishable from valid coins, and thus cannot be later recognized by the bank as stemming from a crime. Few escrowed cash systems protect against blackmailing attacks wherein the blackmailer forces the bank to enter a non-standard withdrawal protocol to withdraw coins (and thereby disable coin tracing mechanisms) or extort the bank's secret key.

Fifth, escrowed cash systems are not secure against bank robbery attacks. Moreover, few escrowed cash systems allow for early detection that the secret keys have been compromised, and once such an attack is detected the system often needs to switch to an on-line mode.

### SUMMARY

The invention relates to systems and methods for executing electronic transactions on an anonymous basis using auditable membership proofs. As noted above, many disadvantages flow from use of the cryptographic technique of blind signatures, including the inability to prevent the issuance of unreported coins and the inability to monitor transactions effectively. Making use of a new cryptographic primitive, referred to herein as a “blind auditable membership proof,” the invention may be configured so as to be anonymous, auditable, or both. A bank need not maintain secrecy of any key because the security of the system may be premised instead on the ability of the bank to maintain the integrity of a public database. The invention may additionally be used to ensure complete anonymity by obviating the need to make individual transactions potentially traceable. The invention may thus be used to execute anonymous electronic transactions without sacrificing security of the system.

In a blind auditable membership proof (“BAMP”), there is a list master, users and verifiers. Each user has one or more elements he wants to put in the list. The user encode their elements and send them to the list master, who forms a list in a way such that each user can efficiently prove that a given element is in the list, or that he knows an element with a certain property that is in the list. No computationally bounded coalition of players can forge a false membership proof. No computationally bounded coalition of players can learn information about the elements in the list other than what is revealed by the users themselves.

Blind auditable membership proof may be advantageously employed in connection with electronic payment systems, wherein the list master is a bank, the user is a customer, and the verifier is a merchant. Blind auditable membership proofs may also implemented in connection with any electronic transaction or interaction in which auditability or anonymity is desired, including voting systems, tax coupons, international currency transfers, and anonymous investing.

An anonymous, auditable electronic payment system can be built using a BAMP protocol. This involves formulation of a list of values L={z₁, . . . ,zₖ}. The elements in the list correspond to valid coins and will be hash values of each coin's serial number and, optionally, some additional information that may be used, e.g., to guarantee anonymity, prevent off-line double spending, or prevent framing. In one embodiment, when a user withdraws a coin z the user chooses x and r (that may both kept secret during withdrawal) and sends z=g(x; r) to the bank. The variable x corresponds to the serial number of the coin z, r is a random number, and g is a concealing and collision resistant function. The collision resistant property of g guarantees that it is infeasible to find a membership proof for an element z not contained in list L. The bank adds the coin z to the public list of coins L, using the method for it from the implemented BAMP protocol.

The coin may be spent anonymously by proving to a merchant with a zero knowledge argument (“ZKA”) that the user knows a pre-image (x, r) of some coin z that appears in the list of coins without actually specifying the value z. The value x may revealed to prevent double spending. Only a person who knows a pre-image (x; r) can use coin z for payment.

A system constructed according to the invention may also be made non-rigid in the sense that each withdrawn coin can later be invalidated by the bank. Such non-rigid systems help prevent blackmail and similar crimes because the public knows which withdrawals stem from the crime and the bank can later invalidate the withdrawn coins.

Electronic transaction systems according to the invention may also be configured so as to be fully private and anonymous. It is not necessary for authorities to revoke anonymity in order to deter criminal activity perpetrated in connection with such systems.

The invention may also be configured so as to obviate the need to maintain secret keys, and thus eliminating the risk that the system will be compromised by theft of a key. The security of the invention against forgery need not critically rely on the secrecy of signature keys or other secret data held by the electronic cash issuer. Instead, the security of the system may rely on the ability of the bank to maintain the integrity of a public database. The invention can optionally be used to ensure that all transactions are fully auditable. The coin list L may be maintained in a public database or otherwise published so that all relevant bank transactions are public and publicly verifiable.

The coins of the invention may also be rendered nontransferable and amount-limited. The combined system even more strongly defends against blackmailing, bank robbery and money-laundering abuses while offering the opportunity for unconditional privacy.

Systems implemented in accordance with the present invention may be used to facilitate monitoring of the money supply in the system. Auditors may provably determine the number of coins that can be accepted for deposit by the electronic cash issuer. The auditor can then match this number with the number of withdrawn coins. In particular, unlike many previous solutions, the auditor does not need to trust the electronic cash issuer.

The invention may be implemented using a variety of transaction platforms and methodologies, including networked and point-to-point communication, as well as electronic, magnetic, and optical readers. The invention can be applied to produce electronic coins that may be useful, for example, in so-called cyber-payment or smartcard-based systems. More generally, thee electronic coins may be embodied for electrical transmission or physical transport on cards or other media, and may support both online and offline techniques for coin verification by merchants.

In one embodiment, the invention provides a cryptographic primitive of a blind, auditable membership proof.

In another embodiment, the invention provides a method for blind, auditable membership proof comprising the use of hash trees.

In a further embodiment, the invention provides an electronic payment system comprising a blind, auditable membership proof.

In an added embodiment, the invention provides an electronic payment system, wherein the security of the system relies on the integrity of public data.

In another embodiment, the invention provides an electronic payment method comprising a user giving a value to the electronic cash issuer, and issuing the electronic coin by adding a function of the value to a publicly verifiable data structure.

In another embodiment, the invention provides a method for implementing systems comprising the step of utilizing membership proofs combined with zero knowledge proofs.

In a further embodiment, the invention provides an electronic payment method, comprising receiving a request to pay electronic coins to a merchant, verifying that the user knows an auditable membership proof for the coins, and, upon successful verification, crediting an account of the merchant in amount of electronic coins to be paid.

In an added embodiment, the invention provides an electronic payment method, comprising a merchant receiving from a user an electronic coin, verifying that the user knows an auditable membership proof for the coin, and upon successful verification accepting these coins as valid payment.

In another embodiment, the invention provides an electronic payment method comprising receiving from a merchant coins and a transcript of a payment process, verifying the coins are valid, verifying that the user knows an auditable membership proof for the coin, and upon successful verification, crediting an account of the merchant in the amount of the electronic coins.

The details of one or more embodiments of the present invention are set forth in the accompanying drawings and the description below. Other features, objects, and advantages of the present invention will be apparent from the description and drawings, and from the claims.

### BRIEF DESCRIPTION OF THE DRAWINGS

FIG. 1 is a block diagram illustrating electronic payment transactions using an electronic coin and a blind auditable membership proof.

FIG. 2 is a flow diagram illustrating electronic payment transactions using an electronic coin and a blind auditable membership proof.

Like reference numerals in the various drawings indicate like elements.

### DETAILED DESCRIPTION

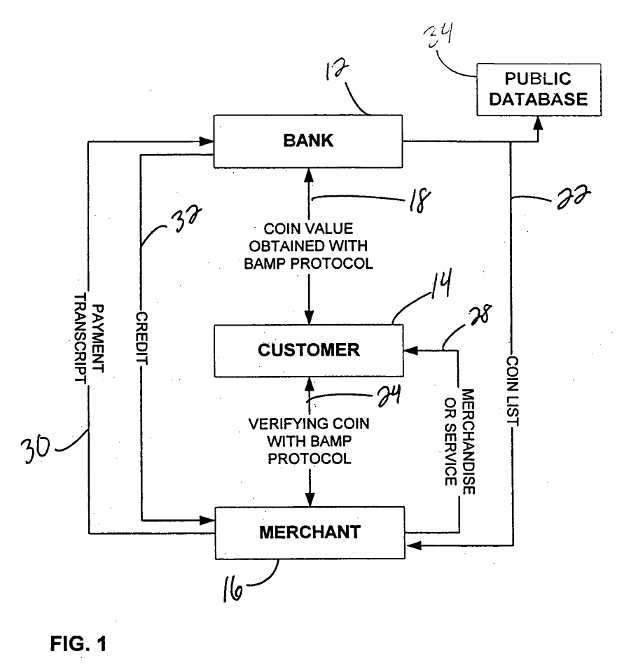

FIG. 1 is a block diagram illustrating the use of a blind auditable membership proof in connection with an electronic payment system using electronic coins. As shown in FIG. 1, bank 12 interacts with a customer 14 to validate electronic coins for use in electronic payment transactions, e.g., for purchase of merchandise and services, rent or mortgage payments, utility payments, and the like. The agent who accepts the electronic coins from the customer will be referred to herein as a merchant 16. Consistent with the wide variety of payment transactions envisioned, however, merchant 16 may take the form of a merchandiser, service provider, creditor, mortgagor, utility company, and the like. Bank 12 also interacts with merchant 16 for redemption of electronic coins received from customer 14 as part of an electronic transaction.

The term “coin,” as used herein, refers generally to a unit or any number of units of electronic currency, or money, that is accepted by merchants 16 as payment, and need not be tied to any particular national or regional unit of currency. The term “coin” may include the values associated with the coin, such as serial number x, associated random number r, and coin value z. The coin may be embodied in electronic, optical, or magnetic media carried by customer 14 and/or transmitted electronically between bank 12, customer 14, and merchant 16. Bank 12, customer 14, and merchant 16 may interact with one another through a variety of communication media, including networked communication over a global or wide area computer network such as the Internet, point-to-point communication using a telephone connection or short range wireless connection, e.g., on a Bluetooth® platform. In many cases, interaction between bank 12 and merchant 16 will take place by network communication. The mode by which customer 14 interacts with bank 12 and merchant 16 will vary.

When the electronic coin is stored in physical media, e.g., a “smart” card, magnetic card, bar code card, or the like, the connection between customer 14 and bank 12 or merchant 16 may be by an electronic, magnetic, or optical reader that temporarily interfaces with the customer media to read information from it. Thus, the electronic coins may be encoded on physical media or propagated as signals across a network or point-to-point interface. In the case of network or point-to-point communication, bank 12, customer 14, and merchant 16 may be equipped with computing devices such as desktop or laptop computers, personal digital assistants (PDA's), wireless telephones, interactive televisions, and similar appliances for facilitating exchange of information in support of the electronic transactions. Bank 12 and merchant 16 also should be equipped with appropriate database, messaging, and web server platforms.

With reference to FIG. 1, customer 14 withdraws a coin z=g(x,r) from bank 12 by executing a secure computation protocol with the bank that ensures that the money is well formed (18). Neither x nor r are revealed to bank 12 at that stage. The coin corresponds to a fixed monetary sum defined by values submitted by customer 14 to bank 12. Customer 14 will generally have a pre-existing account with bank 12. Optionally, the system of figure one can be used in connection with a credit card account, in which case customer 14 also preferably has a pre-existing account. In response, bank 12 determines whether coin z has been used before and verifies that the coin z has the necessary parameters to qualify for inclusion in coin list L. Bank 12 then adds coin z to coin list L and transmits authenticating information using the blind auditable membership proof protocol to customer 14 (18), and broadcasts to all system users, including merchant 12, an updated coin list L (22). The broadcasts may optionally be deferred until a certain time interval ends. The coin and authenticating information may be transmitted electronically to customer 14 or encoded in a physical medium such as a smart card carried by the customer.

To make a purchase, customer 14 initiates a purchase order (24). Customer 14 then forwards merchant 16 the authenticating information proving that the customer knows a coin z in coin list L with the right properties using the blind auditable membership proof protocol (24). Customer 14 reveals x to prevent double spending but does not forward merchant 16 the coin value z, thus preserving anonymity. If a sale of merchandise or services is involved, merchant 16 delivers the merchandise or provides the service (28).

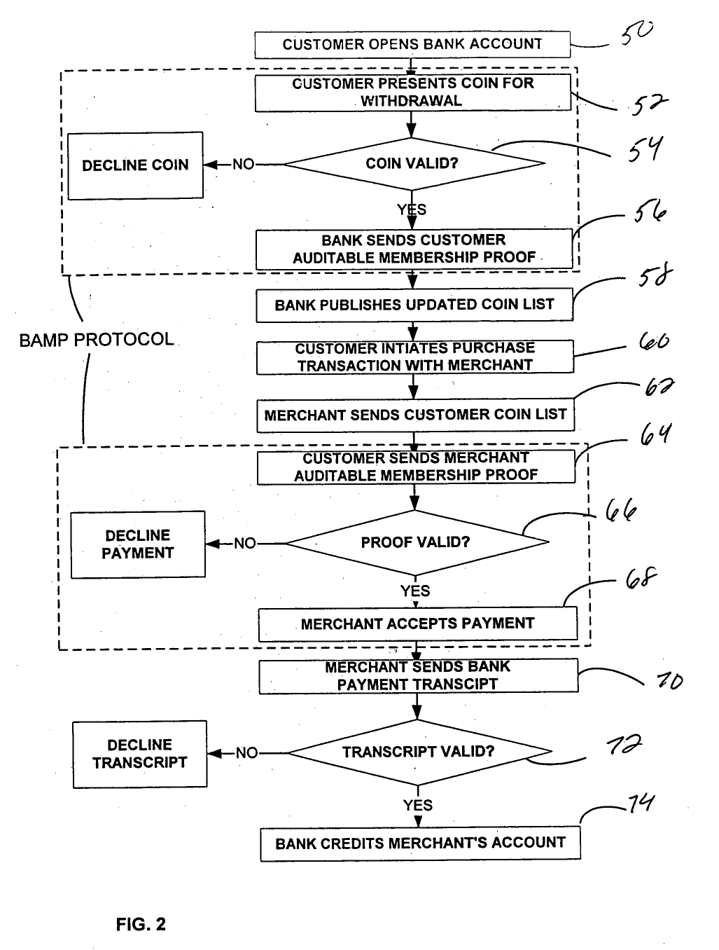

As shown in FIGS. 1 and 2, the term “blind auditable membership proof” includes the authenticating information sent from bank 12 to customer 14 and from customer 14 to merchant 16. The term “blind auditable membership proof” further includes any information supplied by a list master to a user or a user to a verifier that facilitates proof that an element is included in the list.

Merchant 16 deposits funds by transferring a payment transcript to bank 12. The payment transcript may include a merchant identification (m_{id}) and certain authenticating information sent by customer 14 including the serial number of the coin z (30). Bank 12 verifies that a coin having the serial number has not been spent previously and checks the authenticating information. If the transaction proves valid, bank 12 transfers the fixed monetary sum to which the coin z corresponds to merchant 16 (32). Additional mechanisms can be added to provide detection of bank off-line double spenders.

Bank 12 may invalidate coin z by removing it from coin list L and broadcasting an updated coin list L to all system users (18). Optionally, the updated coin list may be maintained in public database 32 having controlled or open access.

The system of FIG. 1 is preferably unforgeable, meaning that it is infeasible for any coalition of participants in the system excluding bank 12 to create an amount of payments accepted by bank 12 that exceeds the amount of withdrawn coins.

The system is auditable, meaning that there is a one-to-one correspondence between all coins z and the withdrawal records and that system does not admit any unreported money. The one-to-one correspondence need not be known to the auditor or anyone else.

The system of FIG. 1 may also be configured so as to enable bank 12 to invalidate coins after they are originally “issued” or validated by the bank. This feature may be referred to as “non-rigidity.” To invalidate a coin z in case of fraud, blackmail or other illegality, bank 12 removes the suspect coins from the public coin list L and distributes the updated list to users and, optionally, a public database.

The system further provides unconditional customer anonymity. A payer has unconditional anonymity if transcripts of withdrawals are statistically uncorrelated to transcripts of payments and deposits. Upon withdrawal, customer 14 must identify herself to bank 12, and bank 12 might record the withdrawn coin value z along with the identity of its owner. Yet, as transcripts of withdrawals are statistically uncorrelated to transcripts of payments and deposits, this does not give bank 12 any information on how or to whom a withdrawn coin is spent.

The system of FIG. 1 is implemented assuming a given blind auditable membership proof primitive. The proofs and definitions underlying the blind auditable membership proof are explained in greater detail below.

The invention may optionally be executed according to the process illustrated in the flow diagram of FIG. 2. FIG. 2 outlines the process by which a blind auditable membership proof is implemented in connection with an electronic payment system that uses electronic coins. The process illustrated in FIG. 2 may be used in connection with the system shown in FIG. 1.

The process of FIG. 2 may be predicated on the following definitions of the relevant assumptions, functions, domains, hash chains, hash trees, and ZKA's. A function of f: A×B→C is one-way if the probability that a polynomial time machine given a random c ε C can find (x, r) such that f(x, r)=c is negligible. A function f: A×B→C is collision resistant if the probability that a polynomial time machine can find (x, r)≠(x′, r′) such that f(x′, r′)=f(x, r) is negligible.

G is a domain of size p. A function g: [0 . . . p-1]×[0 . . . p-1]→G is concealing if for any [0 . . . p-1] the distribution g(x,[0 . . . p-1]) obtained by picking r ε [0 . . . p-1] at random and computing g(x, r) is the uniform distribution over G.

Assuming the commonly made assumption in the construction of cryptographic systems that the computation of discrete logarithms (DLOG) is hard for certain groups of prime order, one-way, collision resistant and concealing functions exist and can be based on the representation problem. More specifically, if g is a group of prime order p, for which DLOG is hard, and g₁, g₂ are chosen at random (so almost always they are two distinct generators of G), then g: [0 . . . p-1]×[0 . . . p-1]→G defined by g(x,y)=g₁^{x}g₂^{y} has these properties.

A hash chain of length l to a root R is a triplet (i₁; x; y) such that f⁽ⁱ¹⁾(x, y)=R, where f⁽⁰⁾(x, y)=h(x, y) and f⁽¹⁾(x, y)=h(y, x). A chain of length d>1 to a root R is a triplet ((i₁, . . . ,i_{d}); x; (y₁, . . . ,y_{d})) such that ((i₁, . . . ,i_{d-1}); f^{(id)}(x, y_{d}); (y₁, . . . ,y_{d-1})) is a hash chain of length d-1. The hash chain starts with the value x and leads to the root R.

For a given domain D and a known hash function h: D×D→D, a hash tree (T; val) consists of a balanced binary tree T, with vertices V, together with a function val: V→D such that for any vertex v with two children v₁ and v₂, val(v)=h(val(v₁), val(v₂)). The only operation that can be performed on a hash tree is UPDATE(leaf, w) where the leaf's value is changed to w and the values of the internal nodes from the leaf to the root are accordingly updated.

Zero knowledge arguments of knowledge (“ZKA's”) are proofs that show that customer 14 knows a witness w to the predicate ø (i.e., ø(w)=True). These proofs are convincing if the prover is polynomially bounded, and the proofs statistically do not reveal extra information. Under the discrete log assumption, any NP predicate has a perfect zero knowledge argument of knowledge.

The system preferably uses non-interactive perfect ZKA's and is also preferably premised upon the random oracle assumption that has been commonly used in the design of electronic cash systems. Assuming the random oracle assumption, and using the techniques described in Bellare and Rogaway, Random oracles are practical: A Pardigm For Designing Efficient Protocols, 1st ACM Conference on Computer and Communications Security, Fairfax, Va., November 1993 (ACM Press) (also appeared as IBM RC 19619 (87000) Jun. 22, 1994), the ZKA protocols can be made non-interactive.

The definitions underlying the auditable membership proofs may be structured as follows. Let X be a set of elements. Let £ be the set of all ordered lists over X. An auditable membership proof for X, is a triple (F, G, V) such that F: £→Z, G: £×X→W and V: X×W×Z→{True, False} such that ∀Lε £, ∀ₓ ε L V(x, G(L, x), F(L))=True. It is infeasible for any coalition of polynomial time players to find a list L ε £, an element x not ε L and w ε W such that V(x,w, F(L))=True. The membership proof is efficient if F; G and V are polynomial time algorithms.

A membership proof that is also anonymous and auditable is called a blind, auditable membership proof. Such a proof includes a protocol between k players P₁, . . . , Pₖ, one central player B. The protocol uses known domains A, R, X, W, W′, Z and functions h: A×R→X, F′: £x→Z, G′: £ₓ×X→W and V′: X×W′×Z→{True, False}, where £x is the set of ordered lists of elements over X. The protocol begins with each Pᵢ having a private input aᵢ ε A, rᵢ εR. Player Pᵢ communicates xᵢ=h(aᵢ,rᵢ) to B and B computes z=F′(x₁ . . . xₖ) ε Z, w₁, . . . wₖ ε W, wᵢ=G′ (xᵢ,{x₁, . . . , xₖ}). P has an algorithm that on input x, wᵢ (and using his private knowledge of aᵢ and rᵢ) produces a tᵢ ε W′ such that V′ (aᵢ,tᵢ,z)=True. The system should be sound in the sense that no coalition of polynomial time players can find x₁ . . . xₖ ε X, a₁ . . . aₖ distinct elements of A, r₁ . . . rₖ ε R, an a not ε [a₁ . . . aₖ} and t ε W′ such that xᵢ=h(aᵢ,rᵢ), for i=1 . . . k, z=F′({x₁ . . . xₖ}), and V′(a,t,z)=True. The system should be blind meaning that for every I⊂{1, . . , k} the values {aᵢ, tᵢ |iε I} are statistically independent of the values {x₁ . . . xₖ}. The protocol is efficient if F′, G′ and V′ are polynomial time algorithms, and Pi and B are polynomial time machines. Natural variants with probabilistic predicates can be defined.

One can then take an efficient (but not necessarily blind) auditable membership proof (F,G,V), e.g., one based on a second pre-image resistant, one-way hash function h: A X R→X such that for any a ε A, F(a,R) is uniform over X, and then set F′=F, G′=G and V′(a,t,z) is True iff t is a zero-knowledge proof of knowledge of r ε R and wε W such that V (h (a,r), w,z)=True.

Referring to the electronic payment process illustrated in FIG. 2, during system setup bank 12 and an auditor choose jointly F_{q}, a field of size q=poly(N); N, an upper bound on the number of coins z bank 12 can issue; G, a group of prime order p for which Dlog is hard; |G|≧q³; an efficient 1-1 embedding E: F³_{q}→[0 . . . p-1]; g: [0 . . . p-1]×[0 . . . p-1)]→G, a one-way, collision resistant and concealing function; D, a large domain satisfying |D|>|G|; h: D×D→D, a collision resistant hash function; and, finally, an efficient 1-1 embedding F: G→D. Bank keeps a hash tree T over D with N leaves. This hash tree is gradually built. There is no need to initialize the tree. Merchant 16 obtains a unique identifying identity, and a random oracle maps time and merchant identity to a random element of F_{q}. Merchant 16 executes one transaction per time unit. Alternatively, merchant 16 adds a serial number to each transaction occurring at the same time unit and is not allowed to use the same serial number twice.

Customer 14 opens an account (50) by identifying herself to bank 12. Bank 12 and customer 14 agree on a public identity P_{A} ε F_{q} that uniquely identifies customer 14.

To make a withdrawal (52), customer 14 authenticates herself to bank 12. Customer 14 picks u₁ ε_{R} F_{q}, serial ε_{R} F_{q} and computes u₂=P_{A}—u₁ε F_{q}, and x=(u₁; u₂; serial) ε F³_{q}. Serial is the serial number of the coin and u₁, u₂ are used to encode the identity of customer 14. Customer 14 also picks r ε_{R} [0 . . . p-1] and sends z=F (g(E(x); r)) ε D to bank 12. Customer 14 gives bank 12 a non-interactive ZKA that customer 14 knows u₁; u₂; serial and r such that z=F(g(E(u₁; u₂; serial); r)) and u₁+u₂=P_{A}, i.e., that the coin is well formed. Bank 12 verifies the ZKA and makes sure that the coin z has not been withdrawn previously (54).

Bank 12 then subtracts funds from the account of customer 14 and updates one of the unused leaves in the tree T to the value z (along with the required changes to the values along the path from the leaf to the root). When the time frame ends (see below), bank 12 takes a snapshot of the tree T and creates a version. After creating the version, bank 12 sends customer 14 the hash chain from z to the root of T taken from the hash tree T (56). Customer 14 checks that she was given a hash chain from z to the public root of the hash tree T.

In an example involving issuance of trees each minute, a new minute tree is generated each minute, and a version of it is taken at the end of the minute. When two minute versions exist, they are combined together to make an ‘hour’ tree, by hashing the two roots together. Similarly, if two hour trees exist, they are combined together to a day tree and so forth. At the end of each hour, day, week, etc., a broadcast message is sent to all users who withdrew a coin during that time period (58). The hour update contains the values of the two minute roots that were hashed together to give the hour tree root. Merchants 16 may follow their own updating policy for the hash tree.

Customer 14 may make a payment to merchant 16 with coin z without revealing the coin z as follows (60). Merchant 16 sends customer 14 the set ROOT S of live roots knows to the merchant 16 (62). A root is alive if it is the root of the tree of the last minute, hour, and day, etc.. Customer 14 then sends merchant 16 serial, time, and the value v=u₁+cu₂, where c=H(time; m_{id}) does not equal 1. Customer 14 then proves to the merchant with a non-interactive ZKA that she knows u₁; u₂; r; R and a hash chain ((i₁, . . . , i_{d}); w; (y₁, . . . ,y_{d})) to R such that R ε ROOTS, w=F(g(E(u₁; u₂; serial); r)) and v=u₁+cu₂ (64). Merchant 16 verifies the correctness of the non-interactive ZKA (66). Customer 14 preferentially does not send z itself to merchant 16, thus ensuring anonymity.

Merchant 16 transfers goods or services to customer 14 and sends the payment transcript to bank 12 (70). Bank 12 checks merchant identity m_{id} and verifies that merchant 16 has not earlier deposited a payment transcript with the particular parameter time (72). Bank 12 also verifies that the challenges are correct (i.e., they are H(time; m_{id})), that the set ROOTS in the payment transcript consist of valid roots, and that the non-interactive ZKA is correct (72). Bank 12 then checks whether a coin having the serial number has already been spent (72). If appropriate, bank 12 credits the account of the merchant 16 and records serial ε F_{q} as being spent along with the values c ε F_{q} and v(=u₁30 cu₂) ε F_{q}.

If serial has been spent before, bank 12 knows two different linear equations v₁=u₁+c₁u₂ and v₂=u₁+c₂u₂. Bank 12 solves the equations to obtain u₁ and u₂, and P=u₁+u₂. Bank 12 then finds the customer 14 with the public identity P.

To invalidate coins, bank 12 removes the coins that should be invalidated from the coin list L and recomputes the corresponding roots and the hash chains for the remaining coins in coin list L. Bank 12 distributes the updated snapshot of the forest and sends the updated hash chains for each of the withdrawn coins in the forest to the customer 14 who withdrew it

Additional details concerning the operation of a system as shown in FIG. 1 and the process of FIG. 2 can be found in T. Sander and A. Ta-Shma, Auditable, Anonymous Electronic Cash, Crypto, 1999, and the publications referenced therein.

While FIGS. 1 and 2 illustrate use of the blind auditable membership proof in connection with electronic payment systems, those skilled in the art will appreciate that the blind auditable membership proofs may be used in connection with any electronic transaction or interaction in which auditability or anonymity is desired, including voting systems, tax coupons, international currency transfers, and anonymous investing.

It is to be understood that while the invention has been described in conjunction with the detailed description hereof, the foregoing description is intended to illustrate and not limit the scope of the invention, which is defined by the scope of the appended claims. Other aspects, advantages, and modifications are within the scope of the following claims.

What is claimed is:

1. An electronic transaction system, comprising a blind auditable membership proof that enables a user to establish that the user knows a value associated with a token in a non-secret membership list of tokens associated with values.

2. The system of claim 1, wherein transactions occurring in the system can be monitored and audited.

3. The system of claim 2, wherein the user remains fully anonymous.

4. The system of claim 3, wherein the token is non-transferable.

5. The system of claim 1, wherein the token can be invalidated.

6. The system of claim 1, wherein the membership lists is distributed to at least one of the party with whom the user transacts and a public database.

7. The system of claim 6, wherein an issuer of the token cannot be forced to issue tokens that cannot be invalidated later.

8. An electronic transaction system, comprising:
an issuer of a token for use in a transaction;
a blind auditable membership proof that enables a user to establish that the user knows a value associated with a token in non-secret membership list that includes tokens associated with values; and
a transacting party which verifies that the user knows an auditable membership proof for the token.

9. The system of claim 8, wherein the user remains anonymous to the transacting party.

10. The system of claim 8, wherein the tokens are non-transferable.

11. The system of claim 10, wherein the tokens can be invalidated.

12. The system of claim 8, wherein the security of the system does not depend on the maintenance of a secret key

13. The system of claim 12, wherein the security of the system relies on the integrity of public data.

14. A method for determining whether to accept a token in connection with a transaction, comprising:
receiving from a user an electronic token;
verifying that the user knows a blind auditable membership proof for the token, wherein the blind auditable membership proof establishes that the user knows a value associated with some token in non-secret membership list of tokens associated with values; and
accepting the token upon successful verification.

15. The method of claim 14, wherein the verification step does not reveal information from which the user's identity can be determined.

16. The method of claim 14, wherein the membership list is maintained by an issuer of the token.

17. The method of claim 16, wherein the issuer transmits information associated with updated membership lists to at least one of the party with whom the user transacts and a public database.

18. The method of claim 14, further comprising the step of removing the value associated with a token from the membership list.

19. The method of claim 14, wherein the verification step further comprises use of membership proofs combined with zero knowledge proofs.

20. The method of claim 19, wherein the verification step further comprises use of hash chains.

21. The method of claim 20, further comprising the step of monitoring and auditing transactions associated with the token

22. An electronic payment method, comprising:
verifying that a user knows a blind auditable membership proof for a coin, wherein the blind auditable membership proof establishes that the user knows a value associated with a coin in a non-secret membership list of coins associated with values;
receiving a request to pay electronic coins to a merchant; and
crediting an account of the merchant in an amount of the electronic coin upon successful verification.

23. A computer program product, tangibly stored on a computer-readable medium, for determining whether to accept a token in connection with a transaction, comprising instructions operable to cause programmable processors to:
receive from a user an electronic token;
verify that the user knows a blind auditable membership proof for the token, wherein the blind auditable membership proof establishes that the user knows a value associated with some token in non-secret membership list of tokens associated with values; and
accept the token upon successful verification.

24. The computer program product of claim 23, wherein the instructions do not require the user to reveal information from which the user's identity can be determined.

25. The computer program product of claim 23, wherein the membership list is maintained by an issuer of the token.

26. The computer program product of claim 23, further comprising instructions operable to cause programmable processors to transmit information associated with updated membership lists to at least one of the party with whom the user transacts and a public database.

27. The computer program product of claim 26, further comprising instructions operable to cause programmable processors to remove the value associated with a token from the membership list.

28. The computer program product of claim 26, further comprising instructions operable to cause programmable processors to verify the user's a user knows a blind auditable membership proof.

29. The computer program product of claim 28, further comprising instructions operable to cause programmable processors to verify that a user knows a blind auditable membership proof through a hash chain.

30. The computer programs product of claim 23, further comprising instructions operable to cause programmable processors to monitor and audit transactions associated with the token.

31. A computer program product, tangibly stored on a computer-readable medium, for determining whether to accept an electronic coin as payment, comprising instructions operable to cause programmable processors to:
verify that a user knows a blind auditable membership roof for a coin, wherein the blind auditable membership proof establishes that the user knows a coin associated with a value in a non-secret membership list;
receive a request to pay electronic coins to a merchant; and credit an account of the merchant in an amount of the electronic coin upon successful verification.
